(19) United States
(12) Patent Application Publication
(10) Pub. No.: US 2006/0067807 A1
(43) Pub. Date: Mar. 30, 2006

(54) Method for binding a sheet stack into a binder, and binding apparatus for carrying out that method

(76) Inventor: Bernd Loibl, Klettgau (DE)

Correspondence Address: BERENATO, WHITE & STAVISH, LLC, 6550 ROCK SPRING DRIVE, SUITE 240, BETHESDA, MD, 20817, US

(21) Appl. No.: 11/230,929

(22) Filed: Sep. 21, 2005

(30) Foreign Application Priority Data
Sep. 21, 2004 (DE) 10 2004 046 039.6

(51) Int. Cl. B42C 9/00

(52) U.S. Cl. 412/6

(57) ABSTRACT

The invention includes an apparatus and method for binding a sheet stack into a binder that comprises a binder spine having an adhesive strip present on its inner side. The sheet stack is inserted into the binder in such a way that the stack's end face comes into contact with the adhesive strip. After the binder contacts the sheet stack, the sheet stack is compressed by means of a pressing device. An adhesive bond is created between the binder spine and sheet stack. The pressing device compresses the binder in such a way, and thereby heats it in such a way, that the binder is permanently deformed.

### CROSS-REFERENCE TO RELATED APPLICATIONS AND CLAIM TO PRIORITY

This application is based upon application number 10 2004 046 039.6, filed Sep. 21, 2004 in the Federal Republic of Germany, the disclosure of which is incorporated herein by reference and to which priority is claimed. This application also is related to application Ser. No. 11/195,863, filed Aug. 3, 2005 in the United States for the invention entitled “Method for Binding a Sheet Stack into a Binder, and Binding Apparatus for Carrying out that Method”.

### FIELD OF THE INVENTION

The present invention concerns a method for binding a sheet stack into a binder that comprises a binder spine having an adhesive strip present on its inner side, the sheet stack being inserted into the binder in such a way that the stack's end face comes into contact with the adhesive strip, after which the binder with the sheet stack is compressed by means of a pressing device, and in that state an adhesive bond is created between the binder spine and sheet stack. The invention further refers to a binding apparatus for binding a sheet stack into a binder having a binder spine and having an adhesive strip present on the spine's inner side, the binding apparatus comprising a pressing device for compressing the binder and the sheet stack.

### BACKGROUND OF THE INVENTION

It has been known for some time to produce company brochures, financial reports, marketing documents, or the like by binding the sheet stack that reproduces the contents into a binder that comprises a binder spine and binder covers continuous therewith. For that purpose, the binder spine has on the inner side an adhesive strip made of hot-melt adhesive. For binding, the combination of sheet stack and binder is put into a binding apparatus embodied as an office machine, and the binder spine is heated sufficiently that the hot-melt adhesive strip becomes plasticized and the ends of the sheet stack in contact therewith sink into the hot-melt adhesive strip. After removal of the combination, the hot-melt adhesive strip cools and thereby forms a permanent bond between the sheet stack and the binder.

Binders of this kind are known, for example, from U.S. Pat. No. 3,437,506, DE Patent 25 28 225, U.S. Pat. No. 4,244,069, U.S. Pat. No. 4,289,330, EP 0 410 197 B1, and GB 2 186 526 A. Binding apparatuses suitable for binding are evident from DE Examined Application 22 56 259, U.S. Pat. No. RE 28,758, U.S. Pat. No. 3,973,787, U.S. Pat. No. 4,129,471, U.S. Pat. No. 4,141,100, DE 38 05 996 C2, and EP 0 581 394 B1. All the binding apparatuses are configured so that the combination of sheet stack and binder is inserted into an input slot that is open at the top, in such a way that the outer side of the binder spine faces downward. The binder spine is placed on a heating plate that closes off the input slot at the bottom, and is heated by that plate.

To ensure that the combination maintains its vertical position, the binding apparatus comprises a pressing device that compresses the combination and holds it in the upright position. The pressing device is, as a rule, embodied so that at least one of the side walls delimiting the input slot is guided displaceably relative to the others, so that the width of the input slot can be modified and the combination can be held pressed between the two side walls.

In the method according to U.S. Pat. No. 3,973,787, binders are used in which the binder spine and also the adhesive strip are wider than the end face, resting thereagainst, of the sheet stack provided for the purpose. For binding, the combination of sheet stack and binder is inserted into the input slot of a binding apparatus in which the two side walls are movable toward one another for the purpose of contact against the outer sides of the binder covers. Arranged at each of the lower ends of the side walls near the heating plate is a respective roller that is resiliently suspended on the side walls. Upon compaction of the combination, these rollers first come into contact against the outer sides of the binder covers, thus ensuring that the externally located sides of the sheet stack achieve good contact with the adhesive strip. The binder cover is, in this context, pushed against the outer sides of the sheet stack. Only after that do the side walls of the input slot come to rest against the outer sides of the binder covers.

The known binding methods that are carried out using the binders and binding apparatuses recited in the documents have the disadvantage that the adhesive bond is not as strong as is necessary, at least when greater stresses need to be applied. Since these methods are used to produce brochures that are often representative in nature, it is essential that the brochures not fall apart even after repeated use.

To solve this problem it is proposed according to the earlier German patent application 103 21 419.4 or corresponding U.S. patent application Ser. No. 10/842,629, not previously published, that in the context of the pressing operation, the pressing device exert a linear pressure either directly onto the sheet stack or from outside onto the binder, and that a fanning-out of the end face of the sheet stack opposite the binder spine be thereby achieved. In contrast to the previously known (U.S. Pat. No. 4,141,100), therefore, a fanning-out of the sheet stack is achieved here by means of a linear pressure exerted by the pressing device either directly onto the sheet stack or onto the combination of sheet stack and binder. By exertion of an appropriately strong linear pressure, fanning-out can be effected in such a way that an adhesive strip plasticized by heat, or also a pressure-sensitive one, penetrates into the interstices between the individual sheets, and a hitherto unattainable strength is thereby achieved in the bond between the binder spine and sheet stack. The fanning-out can be configured, by appropriate adjustment of the linear pressure, in such a way that the width of the end face of the sheet stack becomes greater than the thickness of the sheet stack in the uncompacted region, i.e. in the region that, viewed from the binder spine, is located remotely from the exertion of linear pressure.

The apparatus disclosed in German patent application 103 21 419.4 has in the meantime been improved by way of a further invention that is the subject matter of the (likewise not previously published) German patent application 10 2004 037 806.1 or U.S. patent application Ser. No. 11/195,863. In this binding apparatus the combination of binder and sheet stack is introduced obliquely from above into an input slot with the binder spine bottommost, and placed on a plate. The plate is guided movably out of an initial position toward the end face of the sheet stack. After clamping of the combination of binder and sheet stack, and therefore during exertion of the linear pressure, the plate is moved toward the end face of the sheet stack, and as a result the binder spine having the adhesive strip is pressed against the sheet stack.

WO 01/62512 A2 discloses a binding apparatus in which a combination of sheet stack and binder is inserted, with the binder spine bottommost, into an input slot and is then immobilized above the binder spine by means of clamping bars (cf. the exemplifying embodiments according to FIGS. 15E. and 15F, as well as the description on page 13, line 6 to page 14, line 6). This is intended to make it possible to use adhesive strips that are wider than the thickness of the sheet stack. This in turn is intended to produce better wetting of the outer sides of the sheet stack, and moreover to make room for excess adhesive to flow in CH 364 242 and CH 333 541 also disclose binding apparatuses having clamping strips that immobilize the binder above the binder spine by clamping.

To ensure that after binding, the sheet stack and binder form a compact and durable unit, it is necessary for the spine width to be adapted, within narrow limits, to the thickness of the sheet stack. This in turn makes it necessary to keep on hand, for sheet stacks of various thicknesses, a large number of binders having different binder spine widths. This is costly for the manufacturer of the binders, and cumbersome and space-consuming (because of the number of binders that must be stocked) for users. The risk furthermore exists that a specific sheet stack will have associated with it a binder that does not fit it, and that incorrect binding will thus occur.

### SUMMARY OF THE INVENTION

It is the object of the present invention to make available a method that substantially reduces the outlay for stocking binders of different binder spine widths. A further object is to design an apparatus suitable therefor.

The first object is achieved, according to the present invention, in that the pressing device compresses the binder in such a way, and thereby heats it in such a way, that the binder becomes permanently deformed. The basic idea of the invention is therefore to deform the binder, by the action of pressure and heat, so that it adapts, proceeding from the binder spine, to the thickness of the sheet stack that is to be bound in. For a specific sheet stack it is thus also possible to use binders whose binder spine is considerably wider than the sheet stack to be bound in, so that with it, sheet stacks within a substantially larger thickness range can be bound. For a specific thickness range, it is thereby possible to make do with a considerably smaller number of binders having different binder spine widths, i.e. the relevant thickness spectrum is completely covered with a considerably smaller number of different binders. The result for the manufacturer is larger production volumes, while the user needs to procure only a few different binder spines in order to cover the spectrum of sheet stack thicknesses respectively pertinent to him. Considerable advantages are thereby obtained overall, both for manufacturers and merchants and for users. In addition, the risk of incorrect binding is substantially reduced.

In an embodiment of the invention, provision is made for the pressing device to exert on both sides of the binder a linear pressure parallel to and at a distance from the binder spine, and for the binder to be heated via the linear pressure,.the heating preferably being accomplished exclusively via the exertion of linear pressure. It has proven useful for the binder to be impinged upon by the linear pressure at a distance of 0.5 to 2 cm from the binder spine, advantageously by way of protruding pressing bars belonging to the pressing device.

According to a further feature of the invention, it is proposed that the binder spine and the end face of the sheet stack be pressed against one another, upon creation of the adhesive bond, with an additionally applied compressive force. As a result, the adhesive strip is pressed onto the sheet stack, so that the adhesive enters between the sheets of the sheet stack. The compressive force should be applied from outside onto the binder spine. This can occur in planar fashion, for example by moving a plate toward the end face of the sheet stack while the binder is clamped in place. Alternatively, the possibility exists of applying the compressive force in linear form and progressive fashion, for example by way of a roller or the like.

The method according to the present invention is suitable in particular for binders in which an adhesive strip made of a pressure-sensitive contact adhesive or a hot-melt adhesive is used. In the latter case, heating of the hot-melt adhesive to the plasticizing temperature is usefully performed by heating the above-described plate through the binder spine. The plate thus performs a dual function, of pressure exertion on the one hand and heating on the other hand. An adhesive strip whose width corresponds to at least 1.2 times the thickness of the sheet stack in the uncompacted state should preferably be used, in order to ensure that the outer sheets of the sheet stack are also bound in.

It is understood that it is also advantageous, in the context of the above-described method, if the sheet stack is fanned out by the compression in such a way that the width of the end face of the sheet stack becomes greater than the thickness of the sheet stack in the uncompacted region. This is brought about, in particular, by the linear pressure exertion already described above.

The second part of the object is achieved, according to the present invention, in that the pressing device comprises heating devices for heating of the binder on both sides, preferably in such a way that two pressing bars, movable relative to and toward one another, are provided, which are mounted on holding elements in such a way that they occupy a protruding position with respect to the holding elements even during compaction of the binder, and which are heatable via the heating device. As a result of the linear heating, the moisture content in the binder is locally decreased and a permanent shaping is thereby achieved, in such a way that the binder cover then rests in planar fashion against the two flat sides of the sheet stack, independently of the width of the binder spine.

According to a further feature of the invention, provision is made for the binding apparatus to comprise an input slot having an input opening that is delimited on the inner side by a support for the binder spine, the pressing bars being arranged at a distance of 0.5 to 3 cm from the support. As a result, the binder is wider than the sheet stack only in the region immediately adjacent to the binder spine.

It is further provided according to the invention for the binding apparatus to comprise a pressing-on device for pressing the binder spine onto the sheet stack upon compaction of the latter. The pressing-on device can be, for example, a pressing ram, placeable against the outer side of the binder spine, which ram in turn is embodied either as a pressing roller rollable over the binder spine or as a pressing plate pressable in planar fashion onto the binder spine. The plate is then movable, preferably displaceable perpendicular to its pressing surface, between an initial position and a pressing position offset toward an input opening for introduction of a binder.

As is known per se, the input opening is usefully open to the side, obliquely, or vertically toward the top. The pressing plate should be movable back and forth via a drive motor between the initial position and the pressing position. If the bond between the binder and sheet stack is to be produced using a hot-melt adhesive, it is advantageous if the pressing plate is equipped at the same time with a heating device for plasticizing the adhesive strip.

The possibility exists of guiding both pressing bars movably in such a way that they are displaceable with respect to one another for pressing the sheet stack. A simpler solution, however, consists in mounting the one pressing bar in a manner fixed to the unit and the other pressing bar displaceably toward and away from the one pressing bar. The movable pressing bar should be driven by a drive motor, for example an electric motor.

It is understood that the binding apparatus comprises a control device with which the drive motor for the pressing plate and the drive motor for the pressing bar or bars are controllable in such a way that after introduction of the combination of binder and sheet stack, firstly the pressing bar(s) is/are brought together, and then the pressing plate is shifted into the pressing position. This ensures that the combination of binder and sheet stack, after introduction into the input slot, is first immobilized before the pressing plate is brought into the pressing position.

### BRIEF DESCRIPTION OF THE DRAWINGS

The invention is illustrated in more detail, with reference to an exemplary embodiment, in the drawings, in which:

FIG. 1 is a perspective view of the binding apparatus according to the present invention;

FIG. 2 is a vertical cross section through the binding apparatus according to FIG. 1;

FIG. 3 is an end view of a binder with sheet stack before the binding operation; and

FIG. 4 is the view according to FIG. 3 during the binding operation.

### DETAILED DESCRIPTION OF THE PREFERRED EMBODIMENT(S)

Binding apparatus 1 depicted in the Figures comprises a housing 2, which is constituted by a lower console 3 that is rectangular in outline and two side panels 4, 5 that project upward vertically from the two short end faces of console 3 and therefore run parallel to one another. Side panels 4, 5 are rigidly joined to console 3, for example by thread-joining or welding.

Extending between the two side panels 4, 5 is a pressing plate 6 that is held in a mount 7 that is guided laterally. Mount 7 sits on the exposed end of a spindle drive 8 that is connected to an electric motor 9. Electric motor 9 sits in a recess 10 of console 3 and is fixedly held therein. By way of spindle drive 8, pressing plate 6 can be moved in accordance with double arrow A back and forth, i.e. perpendicularly to its pressing surface 11, between an initial position (shown here) and an elevated pressing position. The surface is inclined somewhat with respect to the vertical.

Arranged above pressing plate 6 is a bar 12 that extends parallel to pressing plate 6 and is retained fixedly between the two side panels 4, 5. Bar 12 constitutes a pressing bar 13, triangular in cross section, that extends along bar 12 above and parallel to pressing plate 6. Provided opposite bar 12 is a pressing carriage 14 whose end face located opposite bar 12 likewise constitutes a pressing bar 15. The two pressing bars 13, 15 extend over the entire length of pressing plate 6 and lie in a plane that extends parallel to pressing surface 11 of pressing plate 6. Pressing carriage 14 is also guided movably in this plane, in accordance with double arrow B. Pressing bars 13, 15 are each equipped with an electrical resistance heater that extends over the entire length of pressing bars 13, 15.

Pressing carriage 14 sits on a pressing carriage base 16 that is clamped fixedly between side panels 4, 5 and is bent upward at its rear end. Pressing carriage 14 has on the lower side, in the region of a cutout of pressing carriage base 16, a toothed rack (not visible) which meshes with a gear 17 that is mounted, below pressing carriage base 16, rotatably about an axis extending parallel to pressing bars 13, 15. Gear 17 is connected via a linkage (not depicted here) to a drive motor 18 which is arranged between side panels 4, 5 and on which a corresponding support (not shown here in further detail) is held.

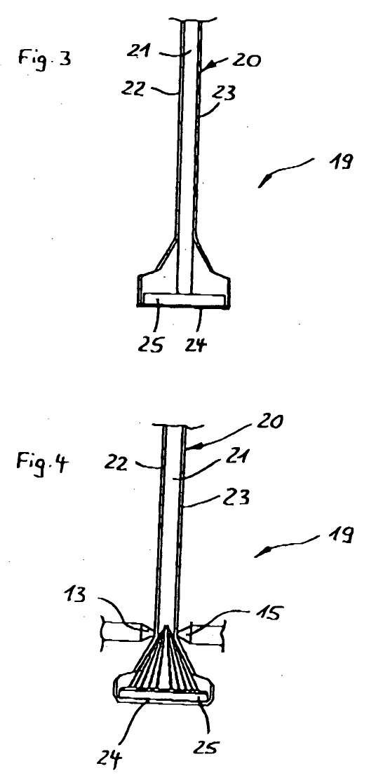

FIG. 3 shows, from the end, a combination 19 of a binder 20 and a sheet stack 21 introduced thereinto that is to be joined to binder 20. Sheet stack 21 can be, for example, of DIN A4 format and comprises a plurality of individual sheets laid congruently one above another.

Binder 20 comprises binder covers 22, 23, a binder spine 24 joining them at the lower ends, and a hot-melt adhesive strip 25 applied on the inner side of binder spine 24. In FIG. 3, sheet stack 21 rests with its lower end face on hot-melt adhesive strip 25. The latter, like binder spine 24, is embodied to be substantially wider than the thickness of sheet stack 21.

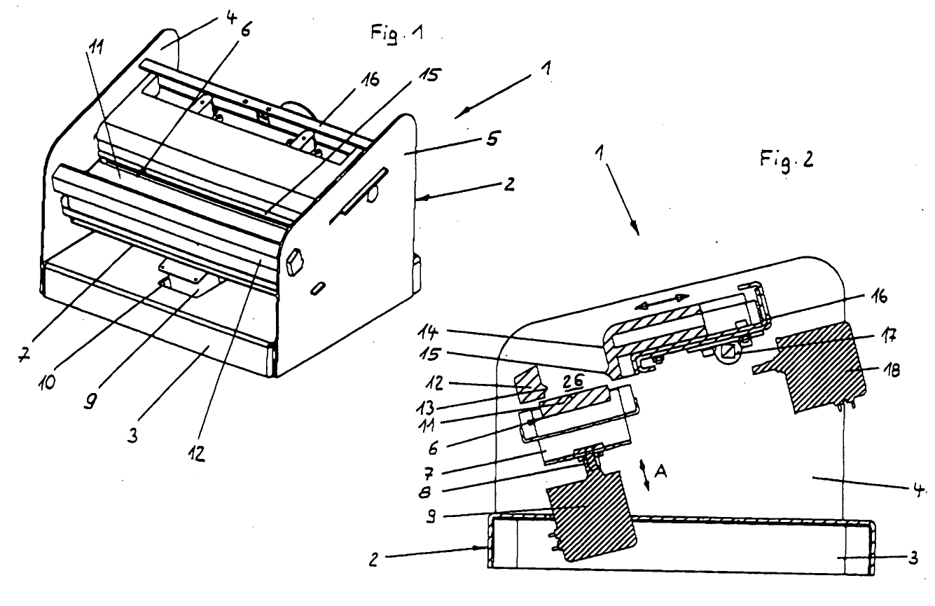

As is once again evident from FIGS. 1 and 2, pressing plate 6, bar 12, and pressing carriage 14 constitute an input slot 26 into which binder 20 as shown in FIG. 3, having an inserted sheet stack 21, can be introduced obliquely from above. This is done, as in the case of the binding machines known in the existing art, in such a way that combination 19 of binder 20 and sheet stack 21 is inserted into input slot 26 with binder spine 24 bottommost, so that binder spine 24 comes into planar contact against pressing surface 11. After insertion, the binding operation is initiated by firstly setting drive motor 18 in motion. This can be effected, for example, automatically by way of a photoelectric barrier that is breached upon insertion of combination 19 of binder 20 and sheet stack 21, or by actuation of an actuation button. Drive motor 18 is caused to move rotationally in such a way that pressing carriage 14 is moved toward bar 12. The consequence of this is that combination 19 of sheet stack 21 and binder 20 is clamped between pressing bars 13, 15 approximately 8 mm above pressing surface 11, with sufficient force that sheet stack 21 is fanned out at the end face located opposite the adhesive strip, so that sheet stack 21 has a greater width at that end face than above pressing bars 13, 15, i.e. where it is not being compacted.

This situation is schematically visible in FIG. 4. It is apparent that pressing bars 13, 15 press binder covers 22, 23 against sheet stack 21 and that the fanning-out of the individual sheets of sheet stack 21, is thereby effected. As a result of the heating of pressing bars 13, 14, binder covers 22, 23 are strongly heated in linear form and locally limited fashion, thus producing, in the region of pressing bars 13, 15, permanent folds from which binder covers 22, 23 extend upward parallel to the sheet stack and in close contact against it, while they diverge from one another only below those folds.

After combination 19 of binder 20 and sheet stack 21 is clamped between pressing bars 13, 15, electric motor 9 is activated in such a way that pressing plate 6 is elevated toward pressing bars 13,15. Binder spine 24 having adhesive strip 25 is thereby pressed firmly against the oppositely located end face of sheet stack 21, the lower sides of bar 12 and of pressing carriage 14 serving as stops for pressing plate 6.

Pressing plate 6 is equipped with a heating device in the form of an electrical resistance heater, so that not only binders having a pressure-sensitive contact adhesive strip on the inner side of the binder spine, but also binders 20 whose binder spine 24 is equipped on the inner side with a hot-melt adhesive strip 25, can be used for the binding operation. The heating device can be controlled in a manner known per se, i.e. the heating device is also switched on when binding apparatus 1 is switched on. Once binder spine 24 has been sufficiently heated and has been pressed against sheet stack 21, pressing carriage 14 is moved back into its initial position as shown, so that combination 19 of binder 20 and sheet stack 21 can be removed and placed upright on a cooling stand. At the same time, the heating device in pressing plate 6 is either switched off or switched into a standby mode, if multiple binding operations are to be performed successively.

It is understood that input slot 26 can also be extended upward, for example by way of a support plate leading upward from bar 12 perpendicular to pressing surface 11. In this fashion it is not necessary for combination 19 of binder 20 and sheet stack 21 to be held manually until it is clamped. Such an extension of input slot 26 furthermore prevents that combination from falling out of binding apparatus 1 after pressing carriage 14 is moved back into its initial position.

I claim:

1. A method for binding a sheet stack (21) into a binder (20) that comprises a binder spine (24) having an adhesive strip (25) present on its inner side, the sheet stack (21) being inserted into the binder (20) in such a way that the stack's end face comes into contact with the adhesive strip (25), after which the binder (20) with the sheet stack (21) is compressed by means of a pressing device (12, 14), and in that state an adhesive bond is created between the binder spine (24) and sheet stack (21),
wherein the pressing device (12,14) compresses the binder (20) in such a way, and thereby heats it in such a way, that the binder (20) is permanently deformed.

2. The method according to claim 1, wherein the pressing device (12,14) exerts on both sides of the binder (20) a linear pressure parallel to and at a distance from the binder spine (24), and the binder (20) is also heated via the linear pressure.

3. The method according to claim 2, wherein the binder (20) is impinged upon by linear pressure at a distance of 0.5 to 2 cm from the binder spine (24).

4. The method according to claim 2, wherein the binder (20) is impinged upon by linear pressure by way of protruding pressing bars (13, 15) belonging to the pressing device (12, 14).

5. The method according to claim 1, wherein the binder spine (24) and the end face of the sheet stack (21) are pressed against one another, upon creation of the adhesive bond, with an additionally applied compressive force.

6. The method according to claim 5, wherein the compressive force is applied from outside onto the binder spine (24).

7. The method according to claim 5, wherein the compressive force is applied in planar fashion.

8. The method according to claim 7, wherein with the binder (20) clamped in place, the binder spine (24) is pressed, by motion of a plate (6) toward the end face of the sheet stack (21), against the latter.

9. The method according to claim 5, wherein the compressive force is applied in linear form and progressive fashion.

10. The method according to claim 1, wherein a binder spine (24) having an adhesive strip (25) made of hot-melt adhesive is used, and this adhesive strip (25) is heated to a plasticizing temperature when the sheet stack (21) is compressed.

11. The method according to claim 1, wherein a binder spine having an adhesive strip made of pressure-sensitive adhesive is used, and this adhesive strip is pressed against the sheet stack when the latter is compressed.

12. The method according to claim 1, wherein an adhesive strip (25) whose width corresponds to at least 1.2 times the thickness of the sheet stack (21) in the uncompacted state is used.

13. The method according to claim 1, wherein the sheet stack (21) is fanned out by the compression in such a way that the width of the end face of the sheet stack (21) becomes greater than the thickness of the sheet stack (21) in the uncompacted region.

14. A binding apparatus (1) for binding a sheet stack (21) into a binder (20) having a binder spine (24) and having an adhesive strip (25) present on the spine's inner side, the binding apparatus (1) comprising a pressing device (12, 14) for compressing the binder (20) and the sheet stack (21),
wherein the pressing device (12, 14) has heating devices for heating the binder (20) on both sides.

15. The binding apparatus according to claim 14, wherein the pressing device (12, 14) comprises two pressing bars (13, 15), movable relative to and toward one another, which are mounted on holding elements in such a way that they occupy a protruding position with respect to the holding elements even during compaction of the binder (20), and which are heatable via the heating device.

16. The binding apparatus according to claim 15, wherein the pressing bars (13, 15) are rigidly mounted on the holding elements.

17. The binding apparatus according to claim 15, wherein the binding apparatus (1) comprises an input slot (26) having an input opening that is delimited on the inside by a support (11), the pressing bars (13, 15) being arranged at a distance of 0.5 to 3 cm from the support (11).

18. The binding apparatus according to claim 13, wherein the binding apparatus (1) comprises a pressing-on device (6) for pressing the binder spine (24) onto the sheet stack (21) upon compaction of the latter.

19. The binding apparatus as defined in claim 18, wherein the pressing-on device (6) comprises a pressing ram (11) placeable against the outer side of the binder spine (24).

20. The binding apparatus as defined in claim 18, wherein the pressing ram is embodied as a pressing roller rollable over the binder spine.

21. The binding apparatus as defined in claim 19, wherein the pressing ram is embodied as a pressing plate (6), pressable in planar fashion onto the binder spine (24), that is movable between an initial position and a pressing position offset toward an input opening for the introduction of a binder (20).

22. The binding apparatus according to claim 21, wherein the pressing plate (6) is mounted displaceably perpendicular to its pressing surface (11).

23. The binding apparatus according to claim 9, wherein the input opening is open toward the side, obliquely upward, or toward the top.

24. The binding apparatus according to claim 21, wherein the pressing plate (6) is movable, via a drive motor (9), back and forth between the initial position and the pressing position.

25. The binding apparatus according to claim 21, wherein the pressing plate (6) is equipped with a heating device for plasticizing the adhesive strip.
